(19) United States
(12) Patent Application Publication
(10) Pub. No.: US 2017/0054940 A1
(43) Pub. Date: Feb. 23, 2017

(54) DEVICE AND METHOD FOR PLAYING AUDIOS AND VIDEOS

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Wei LIU, Beijing (CN)

(21) Appl. No.: 15/241,962

(22) Filed: Aug. 19, 2016

Related U.S. Application Data
(63) Continuation of application No. PCT/CN2016/083913, filed on May 30, 2016.

(30) Foreign Application Priority Data
Aug. 21, 2015 (CN) 201510522720.9

(51) Int. Cl. H04N 7/08; H04N 7/01; H04N 5/445

(52) U.S. Cl. CPC H04N 7/0806; H04N 5/44543; H04N 5/44504; H04N 7/0127

(57) ABSTRACT

Disclosed are a device and a method for playing audios and videos. The method for playing audios and videos includes: producing on screen display menu data; receiving external video signals from an external signal source, and overlaying the on screen display menu data with the external video signals; converting the data format of the overlaid external video signals; and displaying the converted external video signals, thus enabling the method for playing audios and videos to both have high-definition frames and the function of being suitable for executing large-scale software, so as to improve the user experience and willingness to use.

### CROSS REFERENCE TO RELATED APPLICATIONS

This application is a continuation of International Application No. PCT/CN2016/083913, filed May 30, 2016, which is based upon and claims priority to Chinese Patent Application No. 201510522720.9, filed Aug. 21, 2015, the entire contents of which are incorporated herein by reference.

### TECHNICAL FIELD

The disclosure relates to the field of multimedia technologies, and more particularly, to a device and a method for playing audios and videos.

### BACKGROUND

For a solution employed to execute audio and video playing functions, currently a device for playing audios and videos (such as a smart TV) can only meet the use demand of playing a video or playing a small game since the processing capacity of a processor thereof is lower. However, for the use demand of executing large-scale games, its processing capacity for large games is far insufficient. Therefore, if gainers want to execute operations of large-scale games through a general device for playing audios and videos, it is required to purchase an additional game machine to execute, such as Microsoft XBOX ONE or Sony PS4 for playing the large-scale games on a smart TV.

Therefore, the current device for playing audios and videos cannot comply with the use demand for one machine multi-purpose, and additional device is needed, which merely increases the cost, thus resulting in poor user experience so as to reduce their willingness to use the device for playing audios and videos.

### SUMMARY

The present invention provides a device and a method for playing audios and videos which are configured to solve the problems in the prior art that the use demand for one machine multi-purpose cannot be satisfied, which results in poor user experience and the willingness to use the device for playing audios and videos is reduced.

In order to implement the foregoing objects, the embodiments of the present application employ the following technical solutions.

According to a first aspect, it provides a method for playing audios and videos, including:

producing on screen display menu data;

receiving external video signals from an external signal source, and overlaying the on screen display menu data with the external video signals;

converting the data format of the overlaid external video signals; and

displaying the converted external video signals.

According to a second aspect, the present invention also provides an electronic device, including a memory and at least one central processing unit, where the memory is connected to the at least on central processing unit by using a bus, the memory is configured to store a computer instruction, and when the device runs, the at least on central processing units executes the device to execute the following operations: producing on screen display menu data; receive external video signals from an external signal source, and overlay the on screen display menu data with the external video signals; convert the data format of the overlaid external video signals; and display the converted external video signals.

According to a third aspect, the present invention provides a non-volatile computer readable storage medium, where the non-volatile computer readable storage medium stores a computer instruction, and a computer executes the computer instruction to execute the following operations: producing on screen display menu data; receive external video signals from an external signal source, and overlay the on screen display menu data with the external video signals; convert the data format of the overlaid external video signals; and display the converted external video signals.

According to the device for playing audios and videos provided by the embodiments of the present invention, such as a smart TV, the external video signal received by the device for playing audios and videos are suitable to be played on the display screen and on screen display menu can be presented synchronously through the configuration of the system processor which is a high-performance system processor having performance indexes apparently higher than that of a general processor, the configuration of the video processor which is suitable for receiving the external video signals and suitable for overlaying the on screen display menu data with the external video signals, and using the video format conversion bridge chip to convert the data format of the overlaid external video signals and transmit the external video signals to the display screen, and processing the external video signals into the high resolution and high frame rate video signals overlaid with the on screen display menu data by the motion compensation frame rate converter, so that the device for playing audios and videos not only has the efficacy of executing high power consumption software, but also can provide a function for viewing high-quality videos at the same time. Therefore, for the aspect of use, the device for playing audios and videos enables users to view high-quality videos, and can also meet the use demand for executing large-scale games at the same time, so that the entire audio-visual entertainment efficacy of the device for playing audios and videos is enhanced, the user experience is substantially improved, and the cost for additionally purchasing a game machine is saved.

### BRIEF DESCRIPTION OF THE DRAWINGS

In order to explain the technical solutions in the embodiments of the present invention or in the prior art more clearly, the drawings used in the descriptions of the embodiments or the prior art will be simply introduced hereinafter. It is apparent that the drawings described hereinafter are merely some embodiments of the present invention, and those skilled in the art may also obtain other drawings according to these drawings without going through creative work.

FIG. 1 is a block diagram of a first embodiment of a device for playing audios and videos according to the present invention;

FIG. 2 is a block diagram of a second embodiment of the device for playing audios and videos according to the present invention;

FIG. 3 is a block diagram of a third embodiment of the device for playing audios and videos according to the present invention;

FIG. 4 is a block diagram of a fourth embodiment of the device for playing audios and videos according to the present invention;

FIG. 5 is a flow chart of a first embodiment of a method for playing audios and videos according to the present invention;

FIG. 6 is a flow chart of a second embodiment of the method for playing audios and videos according to the present invention; and

FIG. 7 is a block diagram of an electronic device in accordance with some embodiments.

### DETAILED DESCRIPTION

To make the objects, technical solutions and advantages of the embodiments of the present invention more clearly, the technical solutions of the present invention will be clearly and completely described hereinafter with reference to the embodiments and drawings of the present invention. Apparently, the embodiments described are merely partial embodiments of the present invention, rather than all embodiments. Other embodiments derived by those having ordinary skills in the art on the basis of the embodiments of the present invention without going through creative efforts shall all fall within the protection scope of the present invention.

The technical solutions provided by each embodiment of the present invention will be described in details with reference to the drawings hereinafter.

The device for playing audios and videos disclosed by the embodiments of the present invention is used for transmitting the video signals to the display screen, wherein the device for playing audios and videos may be, but is not limited to a TV set, for example, a smart TV, wherein the device for playing audios and videos may also be externally connected to such a device for outputting for audios and videos which may be a video and audio apparatus like a DVD player or a set top box externally connected to the device for playing audios and videos, and the device for outputting for audios and videos is used as an external signal source to receive external audio signals and external video signals from the device for outputting for audios and videos. The above is exemplary and explanatory only, and is not intended for limitation.

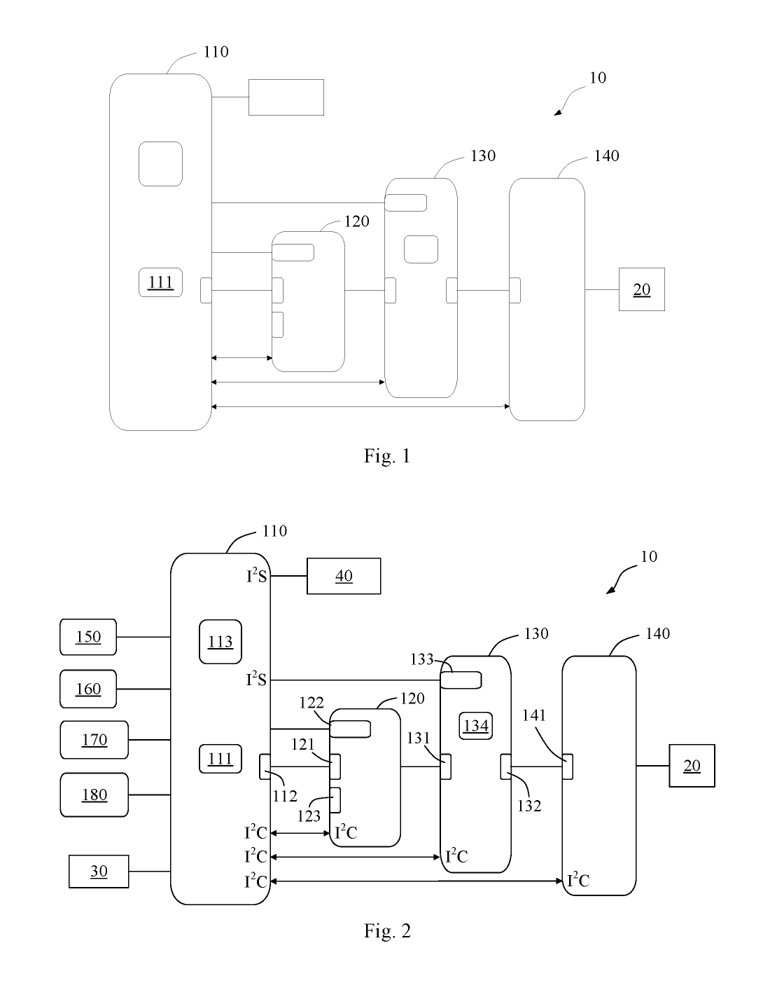

Please refer to FIG. 1. A device for playing audios and videos 10 disclosed by a first embodiment of the present invention includes a system processor 110, a video processor 120 and a video format conversion bridge chip 130.

The system processor 120 is a processor having a master frequency and a register bit higher than that of a general processor. For example, if the general processor has 32 bits and a master frequency of 1.2 GHz, then the system processor 120 may be a 64-bit processor having a master frequency of 2-2.5 GHz, which is a relative value, and thus is not limited to this. The system processor 110 is coupled to the video processor 120 and the video format conversion bridge chip 130 respectively, and the system processor 110 has an on screen display menu function module 111 for producing on screen display menu data.

The video processor 120 is coupled to the system processor 110 and an external signal source respectively for receiving the on screen display menu data and external video signals from the external signal source, and overlaying the on screen display menu data with the external video signals, and transmitting the overlaid external video signals to the video format conversion bridge chip 130. Wherein, the external signal source may be, but is not limited to such a device for outputting for audios and videos like a DVD player or a set top box that is externally connected to the device for playing audios and videos 10.

The video format conversion bridge chip 130 is coupled to the video processor 120 and a display screen 20 for receiving and converting the data format of the overlaid external video signals, and transmitting the converted external video signals to the display screen 20.

In application, when the audio and video signals inputted into the device for playing audios and videos 10 are from an external signal source of such a device for outputting for audios and videos like a DVD player or a set top box, the device for playing audios and videos 10 is externally connected to the external signal source through the video processor 120 and receives the audio and video signals from the external signal source. After receiving the external audio and video signals from the external signal source, the video processor 120 may perform subsequent processing on the external audio and video signals directly, or receive the on screen display menu data corresponding to the audio and video signals from the system processor 110 according to the use requirements, and overlay the on screen display menu data with the video signals in the audio and video signals (i.e., the external video signal from the external signal source), and then transmit the external video signals overlaid with the on screen display menu data to the video format conversion bridge chip 130.

Then, the video format conversion bridge chip 130 converts the data format of the overlaid external video signals (i.e., the external video signals overlaid with the on screen display menu data), for example, from HDMI data format to V-by-One data format, so that the data format complies with the receiving format of the display screen, to facilitate playing the signals on the display screen 20.

Therefore, the device for playing audios and videos provided by the embodiment of the present invention may receive the audio and video signals from the external signal source through the video processor, and the device for playing audios and videos is enabled to possess the ability of processing large-scale software, for example, large-scale games or other high power consumption software, through the configuration of the system processor having performance indexes apparently higher than that of a general processor in the meanwhile. Moreover, the main video signals received by the system processor and the external video signals received by the video processor may be played on the display screen through using the video format conversion bridge chip to convert the data format of the video signals, thus improving the quality of the display frame, and increasing the user experience at the same time.

Please refer to FIG. 2. A device for playing audios and videos 10 disclosed by a second embodiment of the present invention is coupled with a main signal source 30, an audio system 40 and a display screen 20, wherein the main signal source 30 may be, but is not limited to a TV signal source, a signal source from internet or a signal source downloaded from a local end, while the audio system 40 and the display screen 20 may be, but are not limited to multimedia devices self-provided by the device for playing audios and videos 10, or multimedia devices externally connected to the device for playing audios and videos 10 in a detachable form.

The device for playing audios and videos 10 includes a system processor 110, a video process 120, a video format conversion bridge chip 130 and a motion compensation frame rate converter 140, wherein the system processor 110 is coupled to the video processor 120, the video format conversion bridge chip 130 and the motion compensation frame rate converter 140 respectively through an I2C (Inter-Integrated Circuit, inter-integrated circuit) bus. Moreover, the device for playing audios and videos 10 is also internally provided with one of an Ethernet module 150, a wired and/or wireless communication module 160 (such as a bluetooth module, a wifi module, a 2.4G communication module, or the like), a power management module 170, a memory module 180 and combinations thereof which are coupled to the system processor 110 respectively.

In the present invention, the system processor 110 is a processor having a master frequency and a register bit higher than that of a general processor. For example, if the general processor has 32 bits and a master frequency of 1.2 GHz, then the system processor 110 may be a 64-bit processor having a master frequency of 2-2.5 GHz, wherein this is a relative value, and any processor having performance indexes apparently higher than that of a general processor (i.e., so-called high-performance processor) is applicable to be served as the system processor 110 of the device for playing audios and videos 10 in the embodiment of the present invention.

The system processor 110 is coupled to the main signal source 30 of the device for playing audios and videos 10 and is coupled to an audio system 40 through an I2S (Inter-IC Sound) audio bus (also called as integrated circuit built-in audio bus), for receiving audio and video signals of the main signal source 30, for example, audio and video signals transmitted to the processor 110 of the system from one of an Ethernet module 150 and a wired and/or wireless communication module 160 configured in the device for playing audios and videos 10, or audio and video data read by the system processor 110 from a memory module 180. Moreover, the system processor 110 is also configured to transmit the main audio signals from the main signal source (i.e., the audio signals in the received audio and video signals) to the audio system 40 and transmit the main video signals from the main signal source (i.e., the video signals in the audio and video signals of the main signal source) to the video processor 120. Wherein, the main signal source 30 includes: audio and video signals received by such wireless or wired communication modes like the Ethernet module 150 or the wired and/or wireless communication module 160; or audio and video data directly read from the memory module 180, and audio and video signals directly provided by the device for playing audios and videos 10 itself.

Furthermore, a video signal output interface 112, a processing module 113 and an on screen display menu function module 111 are electrically set on the system processor 110. Wherein, the processing module 113 includes a central processing unit (central processing unit, CPU) and/or a graphic processing unit (graphic processing unit, GPU). While the video signal output interface 112 may be, but is not limited to one of a mobile high-definition video-audio standard interface (mobile high-definition link, MHL; referred to as MHL interface), an HDMI interface, a low voltage differential signaling (Low Voltage Differential Signaling, LVDS) interface, a DP port (display port), an EDP port (Embedded Display Port), an MIPI DSI interface (Mobile Industry Processor Interface-Display Serial Interface, mobile industry processor and display serial interface), a logic gate circuit interface (Transistor-Transistor Logic, TTL; referred to as TTL interface) and combinations thereof, and the system processor 110 is namely coupled to the corresponding interface on the video format conversion bridge chip 130 through the video signal output interface 112.

The on screen display menu function module 111 is configured to produce corresponding on screen display menu data according to an operation instruction received by the system processor 110. For example, in a scenario of using a menu, the system processor 110 controls the on screen display menu function module 111 to produce on screen display menu data according to an external input instruction, for example, in the scenario that the device for playing audios and videos 10 of the present invention is a TV set, a function instruction requesting for displaying a control menu is transmitted to the processor 110 through a remote controller, then the processing module 113 of the system processor 110 namely notifies the on screen display menu function module 111 to produce corresponding on screen display menu data according to the function instruction, and transmits the on screen display menu data to the video processor 120; or, the system processor 110 overlays the on screen display menu data with the main video signals, and then transmits the main video signals overlaid with the on screen display menu data to the video processor 120.

The video processor 120 is coupled to the system processor 110, and is coupled to the external a device when the device for outputting for audios and videos such as a DVD player or a set top box is externally connected to the device for playing audios and videos 10 of the embodiment of the present invention, and uses the device for outputting for audios and videos as the external signal source. A video signal input interface 121, a menu data input interface 122 and an external audio and video input interface 123 are electrically set on the video processor 120. The video signal input interface 121 is coupled to the video signal output interface 112 of the system processor 110 for receiving the main video signals from the main signal source 30 from the processor 110. The menu data input interface 122 is coupled to the on screen display menu function module 111 for receiving the on screen display menu data; while the external audio and video input interface 123 is coupled to the external signal source to facilitate receiving the audio and video signals inputted by the external signal source. Therefore, the data format of the external audio and video input interface 122 may be, but is not limited to such interfaces in different data formats like an MEL interface, an HDMI interface, an LVDS interface, a DP port, an EDP port or an MIPI DSI interface or a TTL interface, or the combinations of the foregoing data formats.

Wherein, the main video signals received by the video processor 120 may be but are not limited to the main video signals overlaid with the on screen display menu data, and when the video processor 120 receives the audio and video signals from the external signal source, the video processor 120 may overlay the on screen display menu data with the external video signals from the external signal source firstly, and then transmit the overlaid external video signals, i.e., the external video signals overlaid with the on screen display menu data, to the video format conversion bridge chip 130.

The video format conversion bridge chip 130 is coupled to the system processor 110, the video processor 120 and the motion compensation frame rate converter 140 respectively, and a first video format input interface 131, a second video format output interface 132, an audio output interface 133 and a micro control unit (micro control unit, MCU) 134 are electrically set on the video format conversion bridge chip 130. The first video format input interface 13 is coupled to the processor 110 for receiving the main video signals or the external video signals from the video processor 120, wherein the main video signals and the external video signal may be main video signals and external video signals respectively overlaid with the on screen display menu data. The second video format output interface 132 is coupled to a second video format input interface 141 electrically set on the motion compensation frame rate converter 140, for transmitting the converted main video signals or external video signal to the motion compensation frame rate converter 140 after the data formats of the main video signals and the external video signals are converted by the video format conversion bridge chip 120.

Wherein, the data format of the first video format input interface 131 of the video format conversion bridge chip 130 is the same as the data formats of the video signal input interface 121 and the external audio and video input interface of the video processor 120, for example, all of the three are HDMI data format; while the data format of the second video format output interface 132 of the video format conversion bridge chip 130 is different from the data format of the first video format input interface 131, for example, the data format is V-by-One data format. It is to be understood that because the second video format output interface 132 of the video format conversion bridge chip 130 and the second video format input interface 141 of the motion compensation frame rate converter 140 are a video signal output interface and a video signal input interface with corresponding data format; therefore, the data format of the second video format input interface 141 of the motion compensation frame rate converter 140 in the embodiment is also V-by-One.

Moreover, the audio output interface 133 of the video format conversion bridge chip 130 is coupled to the system processor 110 through an I2S bus for transmitting the converted external audio signals to the system processor 110 after the format of the external audio signals from the external signal source is converted by the video format conversion bridge chip 130, to facilitate providing the audio signals to the audio system 40 to play. For example, after the external audio signals in HDMI are converted into the external audio signal in I2S, the signals are transmitted to the system processor 110 through an I2S bus; or in some cases, the external audio signals in HDMI are firstly converted into SPDIF, then converted into I2S from SPDIF, and then transmitted to the system processor 110.

The motion compensation frame rate converter 140 is coupled to the video format conversion bridge chip 130 and the display screen 20 respectively for receiving the converted main video signals or the converted external video signals from the video format conversion bridge chip 130, and conducting frame rate conversion (frame rate conversion, FRC) on the converted main video signals or the converted external video signals based on motion estimation and motion compensation (motion estimation and motion compensation, MEMC) principle, so as to process the converted main video signals or the converted external video signals into high resolution and high frame rate video signals, for example, improve the video contents with a common refresh rate of 60 Hz to video contents with a refresh rate of 120 Hz or 240 Hz, and then transmit the high resolution and high frame rate video signals to the display screen 20 to play, thus improving the definition of motion frames.

The operation mode of the device for playing audios and videos 10 disclosed by the second embodiment of the present invention will be illustrated hereinafter through a specific implementation manner.

After the system processor 110 of the device for playing audios and videos 10 receives the audio and video signals from the main signal source 30, the main audio signals from the main signal source 30 are transmitted to the audio system 40 through an I2S audio bus; and the main video signals from the main signal source 30 are transmitted to the video processor 120 through the video signal output interface 112. During this process, the system processor 110 also selectively converts the data format of the main video signals into a data format suitable for the video signal output interface 112 according to actual demands, such as HDMI, and then transmits the main video signals to the video processor 120 through the video signal output interface 112. Meanwhile, the system processor 110 may also produce corresponding on screen display menu data through the on screen display menu function module 111 according to an external operation instruction received, and transmit the on screen display menu data to the video processor 120.

The video processor 120 after receiving the above main video signals and the on screen display menu data through the video signal input interface 121, overlays the on screen display menu data with the main video signals, and then transmit the overlaid main video signals to the video format conversion bridge chip 130. It's worth noting that the foregoing operation of overlaying the on screen display menu data with the main video signals may also be completed in the system processor, and then the overlaid main video signals may be transmitted to the video processor 120; at this moment, the video processor 120 may directly transmit the main video signals overlaid with the on screen display menu data to the video format conversion bridge chip 130 for conducting a processing program in next stage.

Then, the video format conversion bridge chip 130, after receiving the foregoing main video signals through the first video format input interface 131, converts the data format of the main video signals into V-by-One from HDMI, and then transmits the converted main video signals to the motion compensation frame rate converter 150 through the second video format output interface 132. Then, motion estimation, motion compensation and frame rate conversion are performed on the converted main video signals through the motion compensation frame rate converter 140, so that the converted main video signals are processed as high resolution and high frame rate video signals. Finally, the high resolution and high frame rate video signals are transmitted to the display screen 20 to play, thus presenting high definition frames on the display screen 20.

Furthermore, when the audio and video signals inputted into the device for playing audios and videos 10 are from an external signal source of such a device for outputting for audios and videos like a DVD player or a set top box, the external signal source is coupled to the video processor 120 through the external audio and video input interface 123, to facilitate transmitting the external audio and video signals to the video processor 120 through the external audio and video input interface 123. After receiving the audio and video signal of the external signal source, the video processor 120 receives the on screen display menu data corresponding to the audio and video signals from the system processor 110 according to the requirements, and overlay the on screen display menu data with the video signals in the audio and video signals (i.e., the external video signal from the external signal source), and then transmit the external audio signals from the external signal source and the external video signals overlaid with the on screen display menu data to the video format conversion bridge chip 130.

Next, the video format conversion bridge chip 130 transmits the external audio signals in the audio output interface 133 to the system processor 110 through the audio output interface 133, and then provides the external audio signals to the audio system 40 to play through the system processor 110. While the data format of the external video signals overlaid with the on screen display menu data is converted through the video format conversion bridge chip 130, for example, converted into V-by-One from HDMI, so that the data format is complied with the output format of the second video format output interface 132, and then the converted external video signals are transmitted to the motion compensation frame rate converter 140 through the second video format output interface 132, to facilitate conducting high resolution and/or high frame rate processing. For example, if the resolution of the external video signals is maximum resolution, resolution processing is not conducted in this case; on the contrary, the resolution of the video signals is processed into maximum resolution if the resolution is not maximum resolution. For example, when the inputted external video signals have 4K*2K resolution, then the video signals are not processed; if the inputted external video signals have 1080P resolution only, then the external video signals are processed to have 4K*2K resolution.

Therefore, the device for playing audios and videos provided by the embodiment of the present invention may optionally receive the audio and video signals from the main signal source through the system processor; or receive the audio and video signals from the external signal source through the video processor, and select corresponding processing mode according to different signal sources. Meanwhile, in the device for playing audios and videos provided by the embodiment of the present invention, the device for playing audios and videos is enabled to possess the ability of processing large-scale software, for example, large-scale games or other high power consumption software, through a manner of configuring the processor having performance indexes apparently higher than that of a general processor. Moreover, the main video signals received by the system processor and the external video signals received by the video processor may be displayed on the display screen to play through using the video format conversion bridge chip to convert the data format of the video signals; and high resolution and high rate video signals may be provided to the display screen through optimizing the converted video signals by the motion compensation frame rate converter, thus improving the quality of the display frame, and increasing the user experience at the same time.

It's worth noting that in the device for playing audios and videos of the embodiment of the present invention, if the system processor and the video processor are closer to the video format conversion bridge chip and long-distance signal wire routing is not needed, or the motion compensation frame rate converter is not used, the function of the motion compensation frame rate converter may be closed, or the configuration of the motion compensation frame rate converter may be omitted.

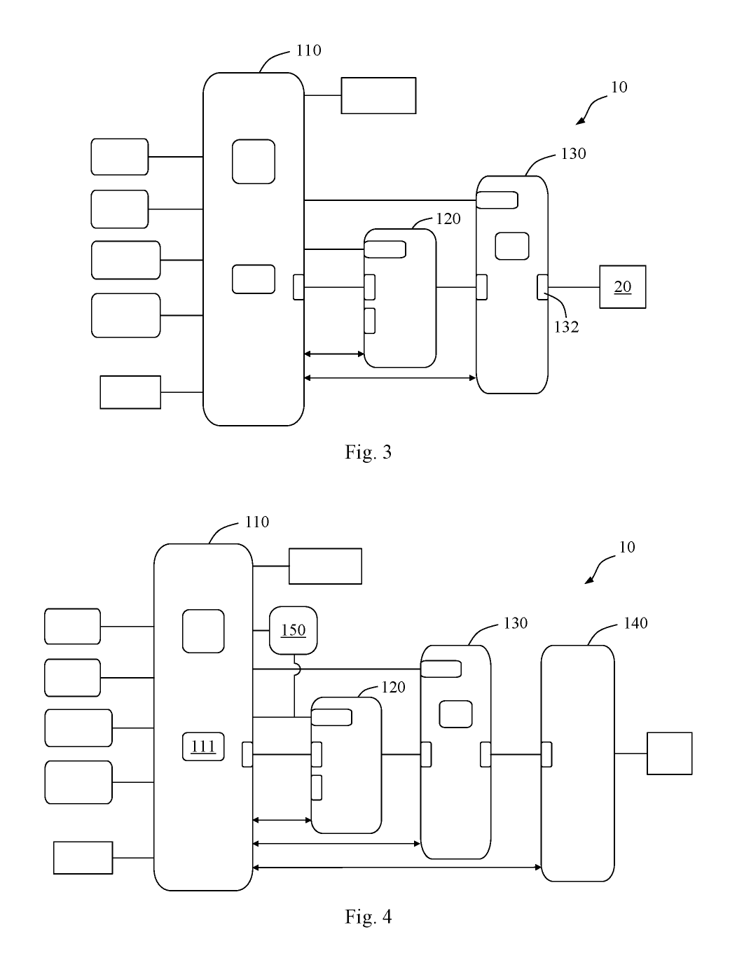

As shown in FIG. 3, in a third embodiment disclosed by the present invention, a device for playing audios and videos 10 includes a system processor 110, a video processor 120 and a video format conversion bridge chip 130. A second video format output interface 132 of the video format conversion bridge chip 130 is coupled to a display screen 20; moreover, after the data format of external video signals overlaid with on screen display menu data is converted by the video format conversion bridge chip 130, the converted external video signals are namely transmitted to the display screen 20 to play through the second video format output interface 132, thus omitting the configuration of a motion compensation frame rate converter.

In addition, FIG. 4 is a block diagram of a fourth embodiment of the device for playing audios and videos of the present invention. The fourth embodiment of the present invention is approximately the same as the second embodiment in system architecture, while the differences between the two lie in that the device for playing audios and videos 10 disclosed by the fourth embodiment of the present invention further includes a menu data format conversion bridge chip 150 which is coupled between the system processor 110 and the video processor 120 for converting the data format of the on screen display menu data into a data format suitable to be received by the video processor 120.

Therefore, in operation, when the system processor 110 receives an operation instruction of requesting to display a control menu, the system processor 110 namely controls the on screen display menu function module 111 to produce corresponding on screen display menu data according to this operation instruction, and then transmits the on screen display menu data to the video processor 120; or, converts the data format of the on screen display menu data through the menu data format conversion bridge chip 150 firstly, and then transmits the data to the video processor 120, to facilitate overlaying the on screen display menu data with the main video signals of the external signal source through the video processor 120, and transmitting the overlaid external video signals or main video signals to the video format conversion bridge chip 130 for data format converting. Finally, the motion compensation frame rate converter 140 is enabled to smoothly receive the converted external video signal or the main video signals, to facilitate performing high resolution and/or high frame rate processing.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in the embodiments. Those having ordinary skills in the art may understand and implement without going through creative work.

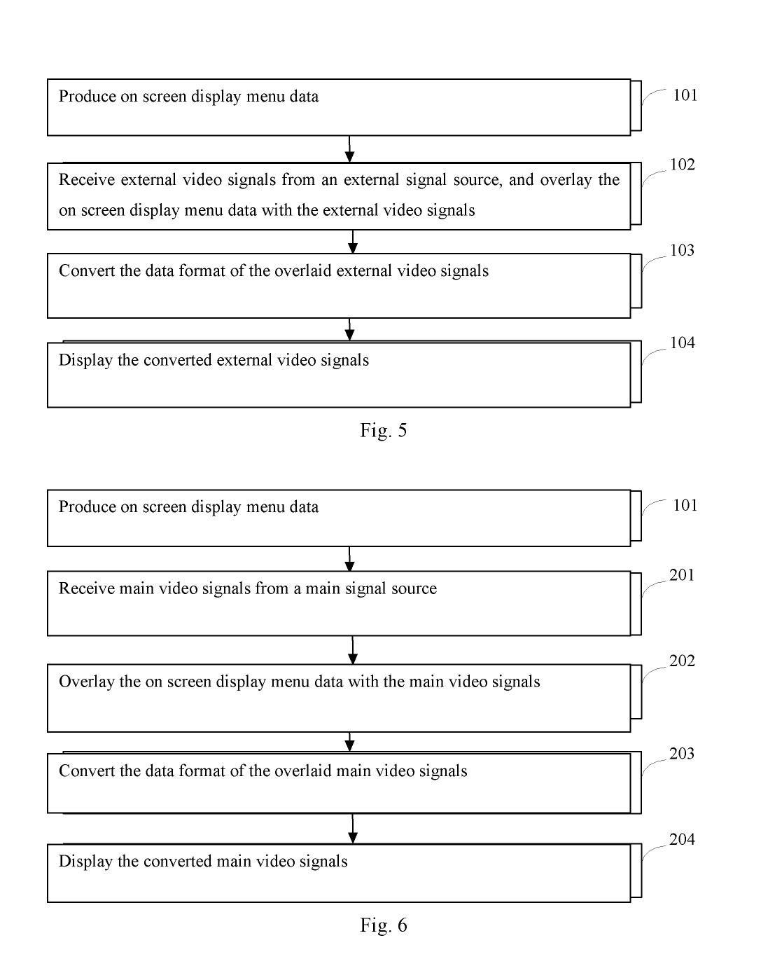

FIG. 5 is a flow chart of a first embodiment of a method for playing audios and videos according to the present invention. As shown in FIG. 5, the method includes the following steps.

In step 101, on screen display menu data is produced.

In step 102, external video signals from an external signal source are received, and the on screen display menu data is overlaid with the external video signals.

In step 103, the data format of the overlaid external video signals is converted.

In step 104, the converted external video signals are displayed.

The executive bodies and implementation manners of various steps in the method provided by the embodiment may refer to the descriptions in the embodiment as shown in FIG. 1.

In the embodiment, when the audio and video signals inputted into the device for playing audios and videos are from an external signal source of such a device for outputting for audios and videos like a DVD player or a set top box, the external audio and video signals may either include external video signals or include external audio signals.

After receiving the external audio and video signals from the external signal source, subsequent processing may be directly performed on the external audio and video signals, or the on screen display menu data corresponding to the audio and video signals is overlaid with the video signals in the audio and video signals, i.e., the external video signals according to the use requirements, and then the data format of the external video signal overlaid with the on screen display menu data is converted, for example, from HDMI to V-by-One, so that the data format is complied with the receiving format of the display screen, to facilitate playing the signals on the display screen.

In the embodiment of the present invention, the device for playing audios and videos is enabled to possess the ability of processing large-scale software, for example, large-scale games or other high power consumption software, with reference to the structure composition of the device for playing audios and videos as shown in FIG. 1 to FIG. 4, and through a manner of configuring the processor having performance indexes apparently higher than that of a general processor. Moreover, the main video signals received by the system processor and the external video signals received by the video processor may be played on the display screen through using the video format conversion bridge chip to convert the data format of the video signals, thus improving the quality of the display frame, and increasing the user experience at the same time.

Optionally, the method, after the producing the on screen display menu data in step 101, may also include: a step of converting the format of the on screen display menu data.

In practical application, the system processor may produce corresponding on screen display menu data according to an operation instruction received. For example, in a scenario of using a menu, the system processor produces on screen display menu data according to the control of an external input instruction; for example, in a scenario that the device for playing audios and videos of the present invention is a TV set, a function instruction requesting to display a control menu is transmitted to the system processor through a remote controller, then the system processor produces corresponding on screen display menu data according to the control of the function instruction.

With reference to the embodiment as shown in FIG. 1 or FIG. 2, the on screen display menu data is transmitted to the video processor; in order to make the produced on screen display menu data be adaptive to the processing format of the video processor, the data format of the on screen display menu data may be converted to the data format suitable to be received by the video processor.

Optionally, the method, before the displaying the converted external video signals in step 104, may further include:

processing the converted external video signals as high resolution and high frame rate video signals. Then the displaying the converted external video signal is adaptively changed into: displaying the high resolution and high frame rate video signals.

To be specific, frame rate conversion (frame rate conversion, FRC) may be performed on the converted external video signal based on motion estimation and motion compensation (motion estimation and motion compensation, MEMC) principle, so as to process the converted external video signal into high resolution and high frame rate video signals, for example, improve the video contents with a common refresh rate of 60 Hz to video contents with a refresh rate of 120 Hz or 240 Hz, and then transmit the high resolution and high frame rate video signals to the display screen 20 to play, thus improving the definition of motion frames.

The aforementioned descriptions indicate that the external audio and video signals excluding the external video signal may also include the external audio signals; therefore, the method for playing audios and videos provided by the embodiment may optionally include the following steps of:

receiving external audio signals from the external signal source;

converting the data format of the external audio signals; and

playing the converted external audio signals.

After receiving the external audio signals, in order to make the external audio signals suitable for the playing requirements of the audio system connected through the device for playing audios and videos, it is desirable to convert the format of the external audio signals, and then the converted external audio signals are provided to the audio system to play. For example, after the external audio signals in HDMI are converted to the external audio signal in I2S, the external audio signals are transmitted to the system processor through an I2S bus, and then provided to the audio system to play through the system processor; or in some cases, the external audio signals in HDMI are firstly converted into SPDIF, then converted into I2S from SPDIF, and then transmitted to the system processor, and provided to the audio system to play by the system processor.

In practical application, the device for playing audios and videos may receive the external audio and video signals of the external signal source; in addition, the signal source of the device for playing audios and videos may also be a main signal source which includes main video signals and main audio signals. The main signal source and the external signal source may either exist at the same time, or exist alternatively. With respect to the two different existing situations, the signals processed by the device for playing audios and videos are different, for instance, the signals are main video signals and/or external video signals, which are determined according to the practical application situations, and will not be defined specifically. The process of playing the main audio and video signals from the main signal source is explained hereinafter with reference to FIG. 6. The specific processing process may be understood with reference to the embodiment as shown in FIG. 1 to FIG. 4.

FIG. 6 is a flow chart of a second embodiment of the method for playing audios and videos according to the present invention. As shown in FIG. 6, the method, on the basis of the on screen display menu data produced by the embodiment as shown in FIG. 5, includes the following steps.

In step 201, main video signals from a main signal source are received.

In step 202, the on screen display menu data is overlaid with the main video signals.

In step 203, the data format of the overlaid main video signals is converted.

In step 204, the converted main video signals are displayed.

Wherein, the main signal source may be, but is not limited to a TV signal source, a signal source from internet or a signal source downloaded from a local end.

When the main signal source includes the main audio signals, the method further includes the steps of: receiving main audio signals from the main signal source; and playing the main audio signals through an audio system.

When the main signal source includes the main video signals, the on screen display menu data is overlaid with the main video signals, and the data format of the overlaid main video signals is converted, so that the data format is suitable to be displayed by the display screen.

Certainly, if external video signals from an external signal source are also received at this moment excluding the main signal source, the foregoing processing of overlaying the on screen display menu data and converting the format may be performed on the external video signals and the main video signals respectively.

Optionally, the method, before the displaying the converted main video signals in step 204, further includes:

processing the converted main video signals as high resolution and high frame rate video signals. Accordingly, the displaying the converted main video signals includes: displaying the high resolution and high frame rate video signals.

Frame rate conversion (frame rate conversion, FRC) is performed on the converted main video signals based on motion estimation and motion compensation (motion estimation and motion compensation, MEMC) principle, so as to process the converted main video signals into high resolution and high frame rate video signals, for example, improve the video contents with a common refresh rate of 60 Hz to video contents with a refresh rate of 120 Hz or 240 Hz, and then transmit the high resolution and high frame rate video signals to the display screen 20 to play, thus improving the definition of motion frames.

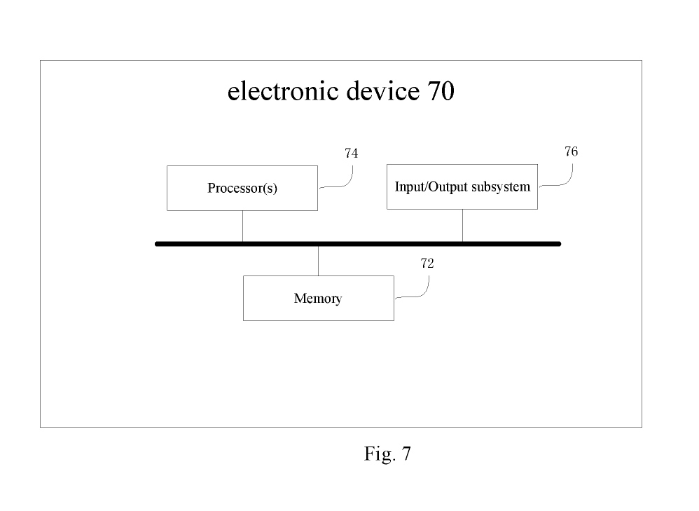

Attention is now directed toward embodiments of an electronic device. FIG. 7 is a block diagram illustrating an electronic device 70. The electronic device may include memory 72 (which may include one or more computer readable storage mediums), at least one processor 74, and input/output subsystem 76. These components may communicate over one or more communication buses or signal lines. It should be appreciated that the electronic device 70 may have more or fewer components than shown, may combine two or more components, or may have a different configuration or arrangement of the components. The various components may be implemented in hardware, software, or a combination of both hardware and software.

The at least one processor 74 may be configured to execute software (e.g. a program of one or more instructions) stored in the memory 72. For example, the at least one processor 74 may be configured to operate in accordance with the method of FIG. 5, the method of FIG. 6, or a combination thereof. To illustrate, the at least one processor 74 may be configured to execute the instructions that cause the at least one processor to:

produce on screen display menu data;

external video signals from an external signal source, and overlay the on screen display menu data with the external video signals;

convert the data format of the overlaid external video signals; and

display the converted external video signals.

As another example, the instructions may further cause the at least one processor to:

receive external audio signals from the external signal source;

convert the data format of the external audio signals; and

play the converted external audio signals.

As another example, before the display the converted external video signals, the instructions may further cause the at least one processor to:

process the converted external video signal as high resolution and high frame rate video signals; and

the display the converted external video signals includes: display the high resolution and high frame rate video signals.

As another example, after the produce the on screen display menu data, the instructions may further cause the at least one processor to:

convert the format of the on screen display menu data.

As another example, the instructions may further cause the at least one processor to:

receive main video signals from a main signal source;

overlay the on screen display menu data with the main video signals;

convert the data format of the overlaid main video signals; and

display the converted main video signals.

As another example, before the display the converted main video signals, the instructions may further cause the at least one processor to:

process the converted main video signals as high resolution and high frame rate video signals; and

the display the converted main video signals includes: display the high resolution and high frame rate video signals.

As another example, the instructions may further cause the at least one processor to:

receive main audio signals from the main signal source; and

play the main audio signals.

In some embodiments, the electronic device is a desktop computer. In some embodiments, the electronic device is portable (e.g., a notebook computer, tablet computer, or handheld device). In some embodiments, the electronic device has a touch-sensitive display. In some embodiments, the electronic device has at least one processor, memory and one or more modules, programs or sets of instructions stored in the memory for performing multiple functions.

Moreover, executable instructions for performing these functions may be included in a non-transitory computer readable storage medium or other computer program product configured for execution by at least one processor. Some embodiments of the present invention provide a non-transitory computer-readable storage medium storing executable instructions that, when executed by an electronic device with a touch-sensitive display, cause the electronic device to execute the steps in the foregoing method embodiments as shown in FIG. 5 or FIG. 6.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally explained that the above embodiments are only configured to explain the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A method for playing audios and videos, at an electronic device with a touch-sensitive display, comprising:
producing on screen display menu data;
receiving external video signals from an external signal source, and overlaying the on screen display menu data with the external video signals;
converting the data format of the overlaid external video signals; and
displaying the converted external video signals.

2. The method according to claim 1, further comprising:
receiving external audio signals from the external signal source;
converting the data format of the external audio signals; and
playing the converted external audio signals.

3. The method according to claim 1, wherein the method, before the displaying the converted external video signals, further comprises:
processing the converted external video signal as high resolution and high frame rate video signals; and
the displaying the converted external video signals comprises:
displaying the high resolution and high frame rate video signals.

4. The method according to claim 1, wherein the method, after the producing the on screen display menu data, further comprises:
converting the format of the on screen display menu data.

5. The method according to claim 1, further comprising:
receiving main video signals from a main signal source;
overlaying the on screen display menu data with the main video signals;
converting the data format of the overlaid main video signals; and
displaying the converted main video signals.

6. The method according to claim 5, wherein the method, before the displaying the converted main video signals, further comprises:
processing the converted main video signals as high resolution and high frame rate video signals; and
the displaying the converted main video signals comprises:
displaying the high resolution and high frame rate video signals.

7. The method according to claim 5, further comprising:
receiving main audio signals from the main signal source; and
playing the main audio signals.

8. An electronic device, comprising:
at least one processor; and
a memory communicably connected with the at least one processor for storing instructions executable by the at least one processor, wherein execution of the instructions by the at least one processor causes the at least one processor to:
produce on screen display menu data;
receive external video signals from an external signal source, and overlay the on screen display menu data with the external video signals;
convert the data format of the overlaid external video signals; and
display the converted external video signals.

9. The electronic device according to claim 8, wherein the instructions further cause the at least one processor to:
receive external audio signals from the external signal source;
convert the data format of the external audio signals; and
play the converted external audio signals.

10. The electronic device according to claim 8, wherein before the display the converted external video signals, the instructions further cause the at least one processor to:
process the converted external video signal as high resolution and high frame rate video signals; and
the display the converted external video signals comprises:
display the high resolution and high frame rate video signals.

11. The electronic device according to claim 8, wherein after the produce the on screen display menu data, the instructions further cause the at least one processor to:
convert the format of the on screen display menu data.

12. The electronic device according to claim 8, wherein the instructions further cause the at least one processor to:
receive main video signals from a main signal source;
overlay the on screen display menu data with the main video signals;
convert the data format of the overlaid main video signals; and
display the converted main video signals.

13. The electronic device according to claim 12, wherein before the display the converted main video signals, the instructions further cause the at least one processor to:
process the converted main video signals as high resolution and high frame rate video signals; and
the display the converted main video signals comprises:
display the high resolution and high frame rate video signals.

14. The electronic device according to claim 12, wherein, the instructions further cause the at least one processor to:
receive main audio signals from the main signal source; and
play the main audio signals.

15. A non-transitory computer-readable storage medium storing executable instructions that, when executed by an electronic device with a touch-sensitive display, cause the electronic device to:
produce on screen display menu data;
receive external video signals from an external signal source, and overlay the on screen display menu data with the external video signals;
convert the data format of the overlaid external video signals; and
display the converted external video signals.

16. The non-transitory computer-readable storage medium according to claim 15, wherein the instructions further cause the electronic device to:
receive external audio signals from the external signal source;
convert the data format of the external audio signals; and
play the converted external audio signals.

17. The non-transitory computer-readable storage medium according to claim 15, wherein before the display the converted external video signals, the instructions further cause the electronic device to:
process the converted external video signal as high resolution and high frame rate video signals; and
the display the converted external video signals comprises:
display the high resolution and high frame rate video signals.

18. The non-transitory computer-readable storage medium according to claim 15, wherein after the produce the on screen display menu data, the instructions further cause the electronic device to:
convert the format of the on screen display menu data.

19. The non-transitory computer-readable storage medium according to claim 15, wherein the instructions further cause the electronic device to:
receive main video signals from a main signal source;
overlay the on screen display menu data with the main video signals;
convert the data format of the overlaid main video signals; and
display the converted main video signals.

20. The non-transitory computer-readable storage medium according to claim 19, wherein before the display the converted main video signals, the instructions further cause the electronic device to:
process the converted main video signals as high resolution and high frame rate video signals; and
the display the converted main video signals comprises:
display the high resolution and high frame rate video signals.

21. The non-transitory computer-readable storage medium according to claim 19, wherein, the instructions further cause the electronic device to:
receive main audio signals from the main signal source; and
play the main audio signals.
